(19) United States
(12) Patent Application Publication
(10) Pub. No.: US 2016/0334939 A1
(43) Pub. Date: Nov. 17, 2016

(54) INTERACTIVE SYSTEM

(71) Applicant: PROMETHEAN LIMITED, Blackburn, Lancashire (GB)

(72) Inventors: Chris Dawson, Blackburn, Lancashire (GB); Andrew Oakley, Blackburn, Lancashire (GB); Andy Dennis, Blackburn, Lancashire (GB); John Macey, Blackburn, Lancashire (GB); Todd Rutherford, Loveland, OH (US); Doug Reinert, Lovelad, OH (US); David Snively, Loveland, OH (US)

(21) Appl. No.: 15/112,850

(22) PCT Filed: Jan. 20, 2015
(86) PCT No.: PCT/EP2015/051033

§ 371 Date: Jul. 20, 2016

(30) Foreign Application Priority Data
Jan. 20, 2014 (GB) 1400895.7

(51) Int. Cl. G06F 3/042; G06F 3/03

(52) U.S. Cl. CPC G06F 3/0425; G06F 3/0308

(57) ABSTRACT

There is disclosed an apparatus, for an interactive system including a display region, arranged to detect the position of a contact point on the display region.

### BACKGROUND OF THE INVENTION

1. Field of the Invention

The present invention relates to interactive systems in which a sensing device is arranged to have a field of view which coincides with a projected displayed image, in order to detect the position of a contact point relative to the displayed image.

2. Description of the Related Art

Interactive display systems are well known. A typical interactive display system provides for the display of an image on a vertical display surface, and detection of contact points on that display surface, to enable selection or manipulation of displayed images for example. Typically such a system providing a vertical display is used in an environment where an audience can see the display, such as a whiteboard in a classroom environment. However interactive systems are not limited to vertical display arrangements, and horizontal display arrangements may also be provided for example. In such an application a table-top type display is provided for one or more users.

In a known interactive display system a display is provided by a projection apparatus. Also in a known interactive display system detection of a contact point on a displayed image is provided by a sensing device such as a camera which captures an image of a projected displayed image.

A typical such interactive display system is shown in FIG. 1. In the Figure, a whiteboard 10 having a display surface 12 is associated with electronic circuitry 14 which includes image drivers 16 for receiving signals from an image sensor, and projector drivers 18 for providing signals to a projection apparatus. The two driver blocks 16, 18 are connected to processing circuitry 20 of the electronics 14. In the figure there is illustrated a single protrusion 22 which houses both the projection point and sensing point of the system.

Such a system operates by projecting an image onto the display surface 12, a projector within the protrusion 22 being located such that its field of view results in a projected image being displayed on the display surface. A sensing device such as a camera is also positioned within the protrusion, and has a field of view which coincides with the field of view of the projector, to capture the displayed image, and any contact point on the displayed image. The distance of the projector is determined to ensure projection onto the display surface 12. The sensing device is positioned adjacent to the projector, at a distance from the display surface 12 determined by the position of the projector, such that the sensing field of view coincides with the projected field of view.

In prior art systems, the distance of the sensing device from the display surface is determined by the distance of the projector from the display surface. The sensing device is then positioned adjacent the projector.

In prior art systems, the distance of the sensing device from the display surface is determined by the size of the display surface, to maximise the field of view of the projected image onto the display surface. If the display surface is changed, for example by changing a whiteboard, then the system cannot be fully utilised. The positioning of the sensing device and the projector for a given size of display surface results in the apparatus only being useful for that size of display surface.

It is an aim of the invention to provide improvements to such an interactive system.

### SUMMARY OF THE INVENTION

There is provided an apparatus, for an interactive system including a display region, arranged to detect the position of a contact point on the display region, the apparatus including a projection device having a projection point for projecting an image onto the display region, and an image sensing device having a sensing point for detecting a contact point on the display region, the distance of the projection point from the plane of the display region being optimal for projection from the projection point onto the display region, and the distance of the sensing point from the plane of the display region being optimal for sensing of the contact point on the display region.

The optimal position of projector and sensor may be inherently linked in some respects—if the choice of projector defines the projector position, and this position happens to potentially restrict locating the sensor in the optimal position for the sensor, (from a perspective of perpendicular distance from the display surface) then the offset axis allows the optimum perpendicular distance to be maintained. In other words there is a locus which is parallel to the display surface along which a constant (optimum) perpendicular distance is achieved, and on which the projector and sensor focal point may be freely placed.

‘Optimal’ can thus be understood, if necessary, with the concept of a horizontal locus parallel to the board of a constant perpendicular distance.

The distance of the projection point from the plane of the display may be optimised in dependence on the size of the display region.

The optimal distance of the projection point from the plane of the display region may be the minimum distance of the projection point from the plane of the display region required to project an image onto the display region.

The distance of the projection point from the plane of the display may be optimised based on the largest size of the display region.

The projection point may be adjusted according to the display size.

The display pixel size may be determined by the distance of the projection point from the display region.

The projection point may be adjusted according to the projector.

The apparatus may further comprise a projector arm, the projector being slidably adjustable on the projection arm to the projection point.

The sensing point may be determined in dependence on the size of the display region.

The sensing point may be chosen after the projection point is chosen.

The sensing point may be optimised for the largest display size. The sensing point may be determined and fixed. A sensing pixel size may be fixed.

The sensing point may be fixed to allow for sensing of the largest display size, and the projecting point is dynamically adjusted in dependence on the current display size.

The sensing point may be fixed to allow for sensing of the largest display size, and the projecting point is dynamically adjusted in dependence on the projector used.

The optimal sensing point may be chosen, and then the optimal projecting point is chosen.

A sensing region may correspond to the display region.

A sensing field of view may be coincident with a projected field of view.

The sensing point may be located on a separate axis to an axis on which the projection point is located, the image sensing device located at the sensing point being tilted so that the sensing field of view coincides with the projected field of view.

The image sensing device may be tilted such that the central axis of the image sensor is coincident with the central axis of the displayed image.

The optimal distance of the sensing point from the plane of the display region may be the minimum distance from the display region required to sense a contact point in the sensing region.

The distance of the projection point from the plane of the display region may be independent of the distance of the sensing point from the plane of the display region.

The distance of the projection point from the plane of the display region may be variable

The distance of the sensing point from the plane of the display region may be variable.

The distances may be variable independently.

The distance of the projection point from the plane of the display region may be different to the distance of the sensing point from the plane of the display region. The distance of the projection point from the plane of the display region may be greater than or equal to the distance of the sensing point from the plane of the display region.

The distance of the sensing point from the plane of the display region may be determined after the distance of the projecting point from the plane of the display region is determined.

A projector at the projection point may not interfere with or obscure the detection of a sensor at the sensing point.

The projection point and the sensing point may be provided on a first axis and a second axis. The first axis and the second axis may be perpendicular to the plane of the display region.

A support housing for the projection point and the sensing point may be provided on a third axis perpendicular to the plane of the display region. The third axis may be distinct from the first or second axis. The display region may be a vertical region, and the first and second axes may be coincident with the plane of the display region above the displayed image proximate to the display region. A fixing for the sensing point and the projection point may be provided on the third axis.

There may be provided methods for implementing apparatus features.

There is provided an apparatus, for an interactive system including a display region and arranged to detect the position of a contact point on the display region, the apparatus including a projection device having a projection field of view and an image sensing device having a sensing field of view, the sensing field of view field of view encompassing the projection field of view and extending outside of the projection field of view.

The apparatus may further include a projector for projecting a displayed image to form the display region.

The sensing device may be adapted to have a sensing field of view which is asymmetrical with respect to a central point of the sensing device.

The sensing device may be adapted to have a field of view which extends outside of the projected field of view in one direction further than it does in another direction.

The display region may have first and second parallel edges, and third and fourth parallel edges perpendicular to the first and second edges, the edges defining a rectangular display region, wherein the sensing field of view extends further beyond the third edge than the fourth edge. The display region may be provided on a horizontal display surface, the third and fourth edges being horizontal edges of a displayed image on the display surface.

A sensing point and a projection point may be provided on separate axes. The first and second axes may be perpendicular to the plane of the display region.

The sensing point may be a variable distance from the display region which is independent of a variable distance of the projection point.

The image sensing device may be tilted so as to adjust the coincidence of the sensing field of view with respect to the projecting field of view.

The image sensing device may be tilted so as to maintain coincidence between the sensing and projecting filed of views.

The image sensing device may be tilted such that the sensing field of view symmetrically extends outside the projected field of view.

There may be provided methods for implementing the apparatus features.

There may be provided an interactive display system comprising a display surface and a display controller for generating an infra-red illumination field across the display surface, the display controller including an infra-red light source, a first partial reflector for receiving the light from the light source and for partially reflecting the light to create a first illumination field and partially transmitting the light to a second reflector, the second reflector for partially reflecting the light transmitted from the first partial reflector to create a second illumination field, wherein the first and second illumination fields form, in combination, the infra-red illumination field across the display surface.

### BRIEF DESCRIPTION OF THE FIGURES

The present invention is described by way of example with reference to the accompanying figures, in which:

FIG. 1 illustrates a typical known interactive system incorporating a projection display apparatus and an image capturing apparatus;

FIG. 2 illustrates an arrangement in which distinct and separate axes are provided for a sensing point and a projection point;

FIGS. 3(a) and 3(b) illustrate in further detail an improvement which may be implemented in the arrangement of FIG. 2;

FIGS. 4(a) and 4(b) illustrate an over-sensing or over-scanning arrangement to ensure the field of view of a sensing arrangement is coincident with a projected image when the projection point and sensing point are provided on distinct and separate optical axes;

FIGS. 5(a) and 5(b) illustrate a sensing tilt arrangement to ensure the field of view of a sensing arrangement is coincident with a projected image when the projection point and sensing point are provided on distinct and separate optical axes;

FIG. 6(a) to FIG. 6(c) illustrate the tilt of a sensing device in arrangements;

FIGS. 7(a) and 7(b) illustrate an over sensing arrangement to ensure the field of view of a sensing arrangement is coincident with a projected image and to accommodate display regions of different sizes and sensing outside the displayed region when the projection point and sensing point are provided on distinct and separate optical axes;

FIGS. 8(a) and 8(b) illustrate a sensing tilt arrangement and an over sensing arrangement to ensure the field of view of a sensing arrangement is coincident with a projected image and to accommodate display regions of different sizes and sensing outside the displayed region when the projection point and sensing point are provided on distinct and separate optical axes;

FIG. 9 illustrates an over-sensing or over-scanning arrangement to ensure the field of view of a sensing arrangement is coincident with a projected image and to accommodate display regions of different sizes and sensing outside the displayed region when the projection point and sensing point are provided on the same optical axes;

FIG. 10 illustrates the exemplary provision of a casing for an illumination source mounted to an interactive whiteboard; and

FIG. 11 illustrates an exemplary implementation of an illumination source.

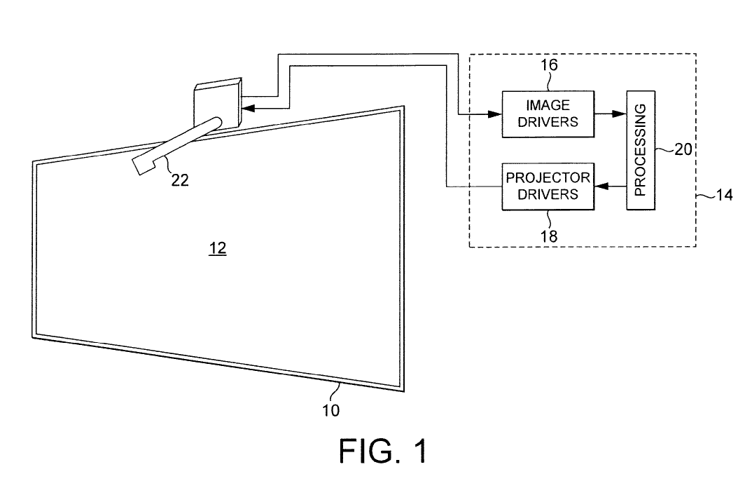

### DESCRIPTION OF PREFERRED EMBODIMENTS

The invention is now described by way of example to particular arrangements and examples in which the invention and its aspects and variations may be utilised. The invention is not limited to the details of any arrangement or example, unless explicitly stated herein or defined in the appended claims.

An apparatus is provided for an interactive system. An interactive system includes a display region and is arranged to detect the position of a contact point on the display region. More specifically, the interactive system is arranged to detect the position of a contact point on a displayed image displayed within the display region.

The display region may be provided on a board, such as a whiteboard, or may be provided on any suitable surface on which images can be displayed. The surface on which images are displayed within is a display surface. An example suitable surface is a substantially flat wall. Where a whiteboard is provided for the display region, the display surface may comprise the entire whiteboard surface or only a part of the whiteboard surface. The size of the display surface is variable, and will be defined by an implementation. The arrangement is not limited to the size or type of the display surface.

The apparatus includes a projection apparatus for providing displayed images onto the display surface. The interactive display system may incorporate any projection arrangement, for example sort throw projection or ultra-short throw projection. The invention is not limited to the type of projection.

The apparatus includes a sensing device arranged to detect contact points at the display surface of the display region. The sensing device is preferably an imaging device which captures an image of the display surface or display region. The sensing device is preferably a camera device, having a field of view which encompasses the display surface of the display region.

The apparatus is preferably utilised in an interactive system including a display region and arranged to detect the position of a contact point on the display region, including a projection device for projecting an image onto the display region, and an image sensing device having a field of view encompassing the display surface and adapted to detect a position of a contact point in the display region.

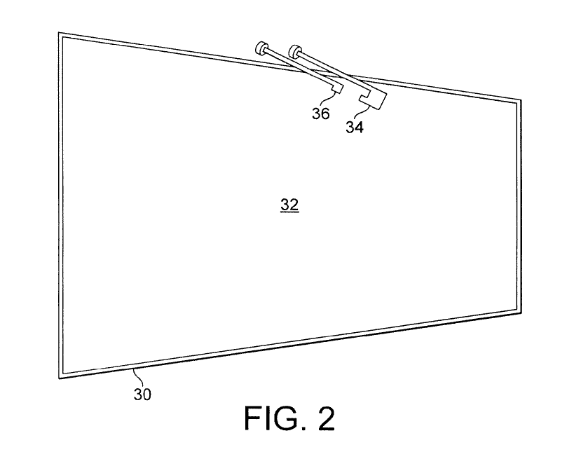

A preferred arrangement of an interactive system in which arrangements and advantages are utilised is illustrated in FIG. 2. Such arrangement illustrates a combination of features in a preferred implementation, but not all the features shown and described will be required in combination for any given implementation. The features described herein may be utilised in an arrangement individually or in combination, in accordance with a preferred implementation.

With reference to FIG. 2 there is illustrated an exemplary interactive system including a whiteboard 30 including a display surface 32 of a display region, a projection apparatus 34 and a sensing apparatus 36.

The exemplary sensing apparatus 36 includes a sensing device comprising an imaging device, preferably formed of a camera. In the exemplary arrangement the camera is provided with a half lens—a full camera lens is adapted such that only half of the lens is provided. This is possible in this arrangement since, owing to the positioning of the camera lens to provide the required sensing, only half of the field of view of the lens is used. The lens therefore preferably retains only the half of the lens providing the desired field of view. In other arrangement a full lens may be used, but the provisions of a half lens saves space in mounting the lens, saves cost with respect to the lens, and saves processing of images collected by the lens.

The exemplary sensing device additionally includes processing circuitry associated with the lens, and it is envisaged that this processing circuitry can be conventional in accordance with the lens design, to process any image data captured by the lens.

The exemplary projection apparatus 34 comprises a short throw projection system. The projection system is not adapted in any way in order to accommodate it within the exemplary apparatus.

In the exemplary arrangement the interactive system is provided with first and second optical axes for providing a projection point and a sensing point. The projector is shown as mounted on one boom arrangement which is disposed such that the projection point is positioned in front of the display region on a projector axis A_{P}, and the sensing point is positioned in front of the display region on a sensing axis A_{S}.

The projection point denotes the point at which images are projected from, and the sensing point denotes the point at which images are sensed.

The projector or projection axis denotes an axis on which the projection point is positioned, and is not necessarily the axis along which a support for the projection point must extend. Similarly the sensing or sensor axis denotes an axis on which the sensing point is positioned, and is not necessarily the axis along which a support for the projection point must extend.

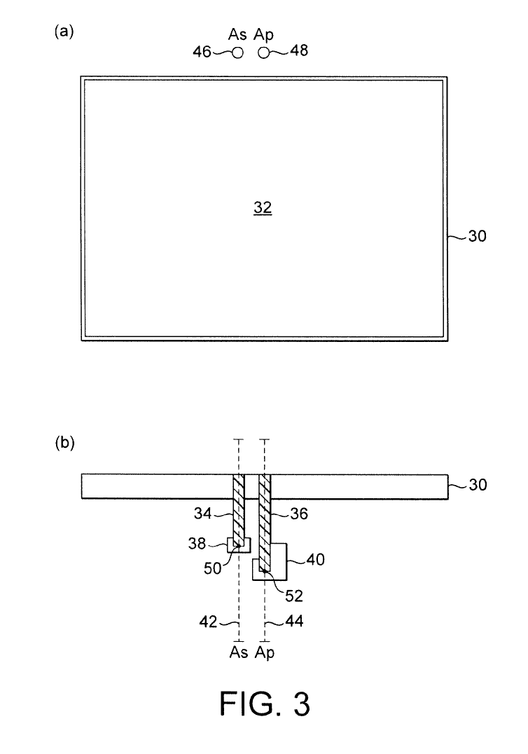

The geometric arrangement of FIG. 2 is further illustrated in FIGS. 3(a) and 3(b). FIGS. 3(a) and 3(b) illustrate different views of the whiteboard and projecting and sensing axes. FIG. 3(a) illustrates a front view onto the whiteboard, and FIG. 3(b) illustrates a downward view onto the top of the whiteboard.

With reference to FIG. 3(a), there is illustrated a whiteboard 30 having a display surface 32. Also shown are points 46 and 48 denoting the points in the plane of the whiteboard surface at which the axis of the projection point and the axis of the sensing point each coincide with the plane of the surface. This, it should be noted, is exemplary, and the exact point of this coincidence may differ. For example the points of this coincidence may in fact be on the display surface 32, the support apparatus for the projector or sensing means which provide the projection point and sensing point being fixed to the plane of the whiteboard surface 32 at points which are not coincident with the display surface 32 itself.

As shown in FIG. 3(b), there is provided a support arm or boom arm 34 which supports the sensing device generally denoted by reference numeral 38, and has an associated sensing point 50 denoted by a dot. There is provided a support arm or boom arm 36 which supports the projection device generally denoted by reference numeral 36, and has an associated projection point 52 denoted by a dot. As shown each of the support arms is provided on a respective axis A_{S} or A_{P}, but as noted hereinabove each support arm may follow a different axis, the axis A_{S} and the axis A_{P} denoting the axis which traverse through the sensing point and projection point respectively.

The display region or display surface preferably comprises a rectangular two dimensional surface bounded by first and second parallel edges and third and fourth parallel edges, the third and fourth parallel edges being perpendicular to the first and second parallel edges. Whilst in the preferred arrangement the display region or display surface is rectangular, the display region may be other shapes. Even when the projection system provides an image of a certain shape, the display surface or display region may be shaped in order to provide a display surface of a different shape. The interactive system is not limited to providing a particular shape of display surface.

The first axis and second axis (A_{S} and A_{P}) are each an optical axis which extends from the two dimensional display region or display surface. In a preferred embodiment, each optical axis extends perpendicularly from the rectangular display surface or display region, and, in the arrangement of the figures, each optical axis is illustrated, for convenience, as being perpendicular to the plane of the display surface or display region.

In general, each optical axis extends away from the display region, such that a projection or sensing device having a projection or sensing point on the respective optical axis can display or capture an appropriate image.

Where the display region or display surface is a two-dimensional area, each optical axis extends away from the plane of the two-dimensional area. Whilst in the particular preferred arrangement each optical axis may be perpendicular to the planar surface of the display area, there is no requirement for each axis to be perpendicular. The preferred requirement relates to the axis containing the projection point and the sensing point, and the actual apparatus which holds the projection point or sensing point may not itself be coincident with the axes of that point. For example, an arm may be provided to support the projection point which extends from the display surface at a particular angle. However the axis which is perpendicular to the display surface passing through the projection point is the relevant axis for discussion.

In the exemplary arrangement the projection axis and the sensing axis are separate, distinct axes. The projection point on the projection axis can be determined independently of the determination of the sensing point on the sensing axis. Each of the projection point and the sensing point can be adjusted by varying its distance to the display surface, this variation being implemented preferably independently. This variation may be achieved, for example, by sliding the housing 38 or 40 along the support arm 34 or 36 respectively, to adjust the respective sensing point 50 or projection point 52.

The projection point represents a point on the projection axis at which images are projected, and thus represents the position at which the projection head is positioned on the projection axis.

The sensing point represents a point on the sensing axis at which images are sensed, and thus represents the position at which the camera lens is positioned on the sensing axis.

Thus with reference to FIG. 3(a), the projection axis and the sensing axis are separate. The figure shows the axes perpendicular to the display region which is planar to the page. As illustrated in FIG. 3(b), the axes are further illustrated, and in this arrangement there is shown that the support elements of each sensing and projecting device is coincident with the relevant axis, but this is not a requirement.

Thus in this aspect of the exemplary arrangement an interactive display system comprises a projector for projecting images onto a display surface, and a sensor for detecting the presence proximate the display surface of an input, wherein a projection point of the projector is on a first axis perpendicular to the display surface and the sensing point of the sensing device is on a second different axis perpendicular to the surface.

In a preferred arrangement where the two optical axes are distinct and separate, the projection point can be determined in order to optimise the projection of images. In such a preferred arrangement the sensing point can also be determined in order to optimise the sensing of images. In a preferred arrangement the projection point and the sensing point are optimally determined independently. This may be an advantage, for example, when the throw ratio (projection distance) of the chosen projector means that the projector and sensor (with sensor positioned for optimum sensing) position would clash from a perpendicular distance perspective, hence the need to offset to separate axes.

The position of the projection point and the position of the sensing point are each preferably optimised to minimise the distance of each respective point from the plane of the display region, whilst observing specific conditions.

The distance of the projection point from the plane of the display region or display surface is optimal for projection from the projection point onto the display region. This distance is optimal, by being the minimum distance under the specific condition that the projected display maximises the display surface: that is, that the projected display substantially fills the display region of the display surface for the required implementation. For a small display surface the distance will be smaller than for a large display surface.

In embodiments, the distance of the projection point from the plane of the display surface is set in dependence on the maximum display size which will be used for a system. In some systems, different display sizes will be accommodated, and the distance of the projection point is optimally set for the largest of these display sizes. In this way the system is agnostic with respect to display or board size.

The optimal position of the projection point will differ according to the projector used, as well as the size of the display. For different projectors, a different projection distance is required for a given display size. Thus the optimal positioning of the projection point additionally take into account the projector or projectors used in the system.

The optimal position of the projection point may be the minimum distance from the display surface, in dependence on the display size to be accommodated and the projector used.

The distance of the sensing point from the plane of the display region or display surface is optimal for sensing from the sensing point. This distance is optimal, by being the minimum distance under which the sensed region can coincide with the display region.

Preferably, the distance is also determined in dependence on reducing or eliminating any interference or obstruction from the projector device.

Preferably, the sensing point is provided on an axis which is closely adjacent to the axis on which the projection point is provided.

Preferably, the position of the sensing point is optimised after the position of the projection point is optimised. Thus the projection point may be optimally determined, and then in dependence on that positioning the sensing point may be optimally determined, taking into account, for example, the interference created by the sensing point due to the location of the projection point, and the positioning of a projector at the projection point.

In terms of optimising the sensing point based on interference, the sensing point may be selected as the minimum distance to the plane of the display required, whilst minimising any interference associated with the projection or any interference caused by a user using the display. The positioning of the sensing point after the positioning of the projection point will also require avoidance of the sensing point providing any interference to the projection.

Thus as particularly illustrated in FIG. 3(b), the projection point of the projection device is shown as being at a different distance from the display region than the sensing point of the sensing device, in this example the projection distance of the projection point being greater than the sensing distance of the sensing point.

Preferably the distance of the projector point from the plane of the display region is greater than or equal to the distance of the sensing point from the plane of the display region.

By providing the projection point and the sensing point on separate, distinct axes, and optimising the position of the projection and sensing points on these axes, the distance of the projection point from the display region can be set independent of the distance of the sensing point from the display region, so that these distances along the respective optical axes can be varied for different implementations. Thus the projecting and sensing distances are decoupled. This breaks the requirement for sensing distance and projector throw distance being the same.

Thus in this aspect of the exemplary arrangement there is provided an interactive display system comprising a projector for projecting images onto a display area, and a sensor for detecting the presence proximate the display area of an input, wherein the perpendicular distance of the projection point of the projector from the display area is different to the perpendicular distance of the sensing point of the sensor from the display area. The sensing point and the projection point are provided on different optical axes.

In an exemplary arrangement the projection axis is positioned centrally to a dimension of the display region. The sensing axis is positioned offset from the projection axis.

As noted above, the display region or display surface preferably comprises a rectangular two dimensional surface bounded by first and second parallel edges and third and fourth parallel edges, the third and fourth parallel edges being perpendicular to the first and second parallel edges. In the preferred example the display region is a whiteboard disposed on a horizontal surface, and the first edge may be an upper horizontal edge, the second edge may be a lower horizontal edge, the third edge may be a left hand vertical edge, and the fourth edge may be a right hand vertical edge.

Preferably, where the display region includes the display surface of an interactive whiteboard, a support arm for the projector and a support arm for the sensing device are mounted above the displayed image.

Preferably a housing is provided for supporting both the projector and the sensing device, having a single mounting point in the plane of the display surface. Thus a single support arm or boom arm may be provided for supporting the projector and the sensing device.

In the preferred arrangement, the projection axis intersects with the plane of the display region or display surface at a position which is proximate the first edge and half way along the first edge. The position of the projection point determines the position of the displayed image on the display region or the display surface, and thus the positioning of this point of the projection optical axes will be determined by the desired positioning of the projected image.

The projection axis is central in so far as it defines an axis which is symmetrical with respect to the first edge, and is positioned such that the first edge is located half on one side of it and half on the other.

In the exemplary arrangement, the sensing optical axis is offset from the projection optical axis, such that it is not symmetrical with respect to the first edge. The sensing optical axis is preferably offset with respect to the projection optical axis, and its position is further determined by minimising its interference with the operation of the system given that the sensing point is located away from—in front of—the surface in order to capture the displayed image. Thus the sensing axis is ordinarily proximate to the projection axis. The sensing device is positioned to minimise interference. By avoiding positioning the sensing device such that it interferes with the projection of an image onto the display area, shadowing in viewing a displayed image in the display area, or in the manipulation of a displayed image—for example by a finger—in the display region, is reduced or negated.

The sensing axis is offset relative to the projection axis, and two arrangements as described below can be provided in order to ensure the offsetting of the sensing axis relative to the projection axis does not inhibit the capture by the sensing device of contact points on the displayed image. These two arrangements can be used independently or in combination. In addition one or both of the arrangements may have additional advantages.

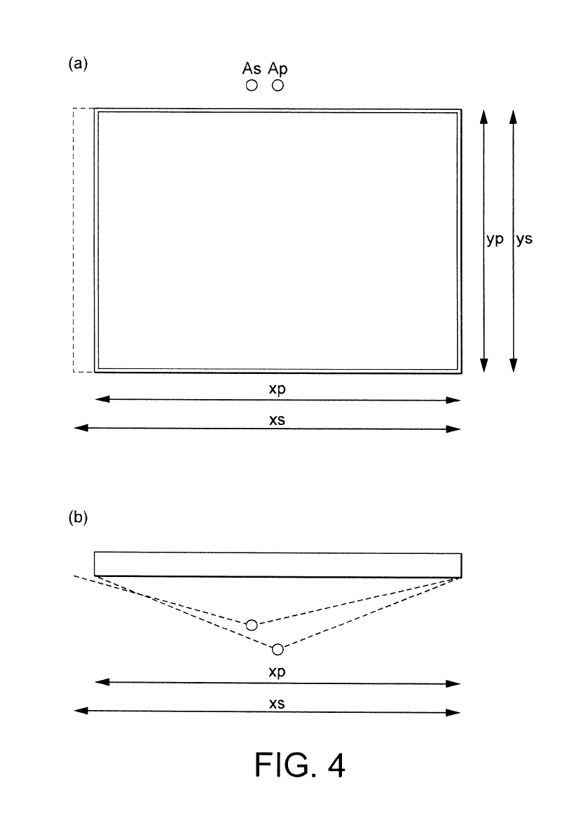

The image capture part of the sensing device, preferably comprising the camera lens, is preferably adapted such that the field of view of the image capture part encompasses the display region entirely, such that a portion adjacent the display surface on the side of the projection axis on which the sensing axis is positioned is encompassed by the field of view of the image capture device. This is illustrated in FIGS. 4(a) and 4(b). In this arrangement, the field of view of the sensing device is increased relative to the field of view of the projecting device.

In this arrangement, the sensing axis is positioned to the left of the projection axis, when looking at the whiteboard. Whilst the projected image is central to the whiteboard, and central about the projection axis, the field of view of the sensing device is clearly not symmetrical about the same point. In order to ensure the sensing device field of view fully encompasses the displayed image, the field of view of the sensing device is increased such that the field of view of the sensing device is greater than the field of view (display) of the projecting device. This is illustrated in FIGS. 4(a) and 4(b).

This arrangement assumes that the projection device projects perpendicularly onto the display surface, and the sensing device senses perpendicularly the display surface.

The increase of the field of view of the sensing device is in order to extend the field of view on the side of the projected image on the other side of the projection axis to where the sensing point axis is located.

Where the field of view of the image capture device is adapted by increasing it to ensure the capture of an area larger than the display area, then a portion adjacent to the display surface on the side of the projection axis on which the sensing axis is positioned is encompassed by the field of view of the image capture device. This is illustrated in FIGS. 4(a) and 4(b).

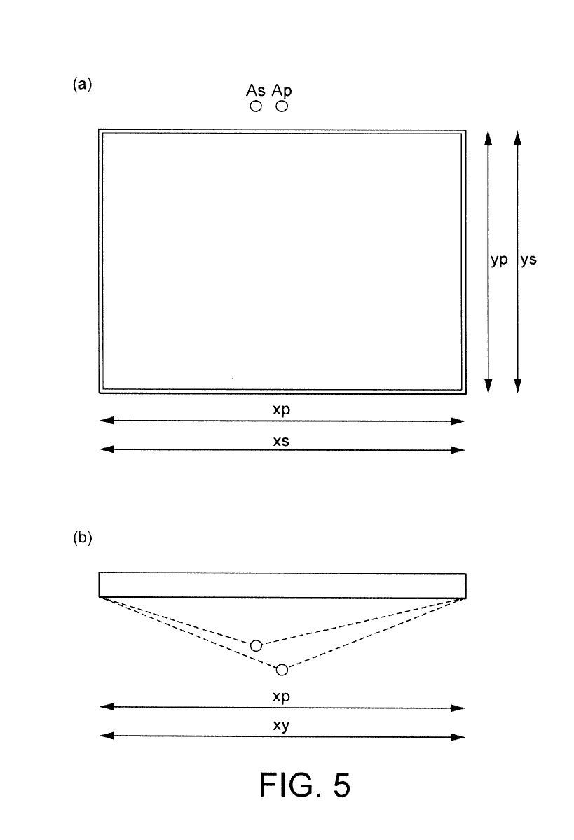

In an alternative to the arrangement of FIGS. 4(a) and 4(b), in accordance with the arrangement of FIGS. 5(a) and 5(b), the field of view of the sensing device may be arranged to coincide with the projected display image by tilting or adjusting the sensing device at its point on the sensing axis. This may be achieved, for example, by tilting the camera lens of the sensing device. By tilting the camera in such a way, the field of view of the sensing device can be made coincident with the projected image.

The image capture part of the sensing device, preferably comprising the camera lens, is preferably adapted such that the field of view of the image capture part encompasses the display region entirely, such that the image capture device is slightly angled relative to the sensing optical axis toward the projection axis. This is illustrated in FIGS. 5(a) and 5(b).

The camera or camera lens is tilted or angled such that its central point is coincident with the central point of the projected image.

In this arrangement, the sensing device is intentionally tilted to purposefully even up the sensing scan with the projection scan. This prevents any problem of missing the edge of the displayed image when the field of view is finely defined to coincide with the display region, or in any arrangement where there is a need to ensure this does not occur. This ensures the entire projected image is sensed without having to increase the sensed field of view as in the arrangement of FIG. 4(a) and FIG. 4(b).

Thus there is provided an interactive display system comprising a projector for projecting images onto a display board, and a sensor for detecting the presence proximate the display board of an input, wherein the projection point is provided on a first axis relative to the display area, and the sensing point is provided on a second axis relative to the display area, a sensing device is positioned at the sensing point and angularly offset relative to the second axis.

The angular offset is determined in dependence on the size of the area the sensor is adapted to detect compared to the size of the area the projector is adapted to illuminate. The angular offset is set according to adjust the central point of the sensor field of view to coincide with the central point of the projection field of view in the x-axis (of a horizontal system such as illustrated).

This is based on the sensor tilt being linked to the display area.

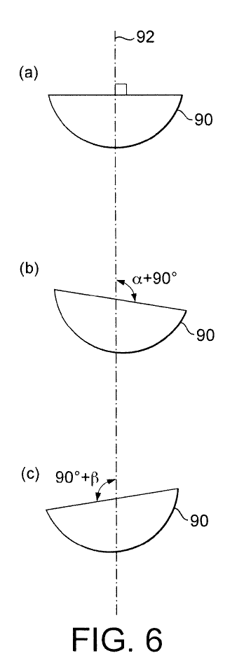

This can be further understood with reference to FIG. 6.

Referring to FIG. 6, there is illustrated a sensing device 90, for example a camera lens, mounted in a housing (not shown) for detecting images in the display region. The dashed line 92 illustrates a perpendicular line from the plane of the display area.

FIG. 6(a) illustrates the lens positioned normally, with a 90° orientation with the viewing window of the sensing device and the axis 92, such that the lens looks directly onto the plane of the display region in a normal fashion, and consistent with the field of view of the projection.

FIG. 6(b) shows the lens tilted in one direction by an angle α. FIG. 6(c) shows the lens tilted in the other direction by an angle β. The tilting of the sensing device in accordance of FIG. 6(b) or 6(c) allows the coverage of FIG. 5(b). The angle through which the lens is tilted will be determined by which side of the projection axis the sensing axis is positioned—this will determine the direction of tilt. The angle is then determined by the amount of angular adjustment need to make the central axis of the field of view coincident with the central axis of the field of view of the projection.

Thus with reference to FIGS. 4(a), 4(b), 5(a) and 5(b) there is illustrated techniques for ensuring that a sensing field of view coincides fully with a display area of a projected image.

In a modification of the described arrangement, the field of view of the imaging device may be increased to cover an area larger than the projected display area, such that the area around the displayed image can be sensed on more than one side of the displayed image.

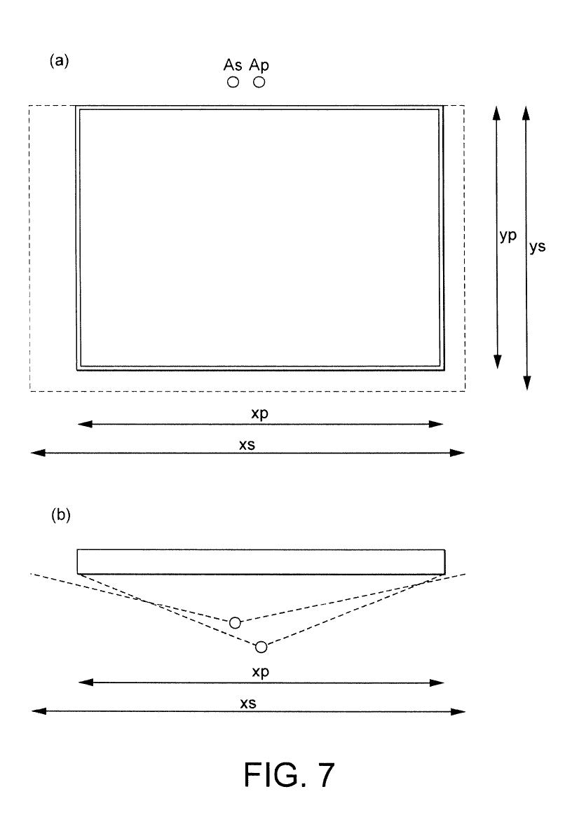

This modification is not limited to an arrangement where the projection point and sensing point are provided on distinct and separate optical axes, but it may be utilised in such a system. Its application to such a system is illustrated with respect to FIGS. 7(a) and 7(b).

Thus where the field of view of the image capture device is adapted to ensure an area larger than the display area is captured, then a portion adjacent the display surface on the side of the projection axis on which the sensing axis is positioned is encompassed by the field of view of the image capture device than is encompassed by a portion adjacent the display surface on the other side of the projection axis.

In the arrangements of FIGS. 4(a), 4(b), 7(a) and 7(b), the field of view of the sensing device is increased. In one arrangement the field of view is increased simply to ensure that the display area is fully sensed, and in the other arrangement the field of view is increased to additionally ensure that a region outside of the display region is additionally sensed.

When a region outside the display region is additionally sensed, contact or gestures in the region outside the display region may be detected. This may allow for the selection of buttons, positioned on the frame of a display area, within this region to be detected for example. The whiteboard frame may be provided with buttons, for example, and selection of those buttons may be detected in this way. Thus a sensor may sense beyond a board surface. The area outside the display surface may be used for buttons, e.g. standby mode, volume etc. Excess of area is covered in the y-plane and/or the x-plane.

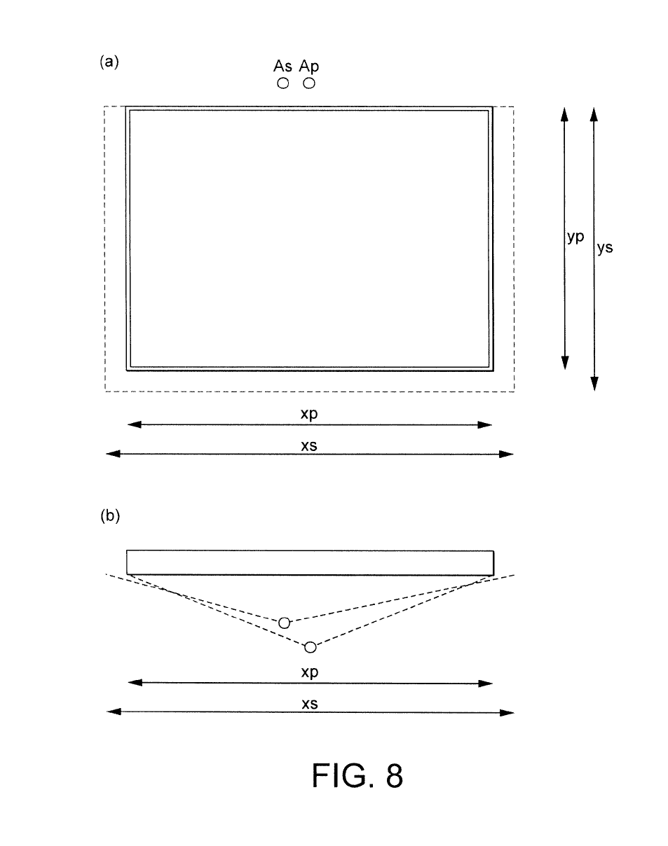

Thus for an interactive display system comprising a projector for projecting images onto a display board, and a sensor for detecting the presence proximate the display board of an input device, the projector may be adapted to display an image in a first area, and the sensor may be adapted to sense the presence of an input in a second area, wherein the first area is within the second area, and the second area is greater than the first area, the area outside the first area but within the second area being used for control purposes for example.

Where the field of view of the image capture device is adapted to ensure the capture of an area larger than the display area, and the image capture device is slightly angled relative to the sensing optical axis toward the projection axis, then a larger portion adjacent the display surface on the side of the projection axis on which the sensing axis is positioned is encompassed by the field of view of the image capture device than is encompassed by a portion adjacent the display surface on the other side of the projection axis. This is illustrated in FIGS. 8(a) and 8(b).

As noted above, the field of view of the sensing device may be extended to be greater than the display area of the projector device to allow for the sensing of additional functions in the region outside the display region. Providing for a symmetrical area in excess of the display area using a tilt applied to the sensing device may be advantageous in providing consistent sizing of the sensing area relative to the display area.

In addition to, or instead of, the provision of an excess sensing field of view area compared to the projected area may be utilised to allow the projection/sensing apparatus to be used with display areas and display surfaces of different sizes, i.e. different whiteboard sizes, without having to change any system settings. Thus a projection and/or whiteboard apparatus can be changed to accommodate a different display size, without having to modify the sensing device. The sensing device can be used for boards of different sizes.

For an interactive display system comprising a projector for projecting images onto a display area, and a sensor for detecting the presence proximate the display area of an input, the display area may be at least one of a first area size or a second area size, and the sensor may be adapted to sense the presence of the input device in an area encompassing the first and second areas.

The projector and camera may be positioned in one location for all board sizes. Thus for an interactive display system comprising a projector for projecting images onto a display area, and a sensor for detecting the presence proximate the display area of an input device, the display area may be at least one of a first area size or a second area size, and the sensor may be adapted to sense the presence of the input device in an area encompassing the first and second areas.

The use of the offset sensing device on the optical axis allows optics to be designed to provide an oversized sensing field of view to accommodate different board sizes.

The offset sensor can be positioned either side of the projector. Thus for an interactive display system comprising a projector for projecting images onto a display board, and a sensor for detecting the presence proximate the display board of an input device, where the projector is mounted on a first axis perpendicular to the board and the sensor is mounted on a second different axis perpendicular to the board, the display area may be at least one of a first area size or a second area size, and the sensor may be adapted to sense the presence of an input in an area encompassing the first and second areas.

Aspects of the described advantageous arrangement are associated with a system in which separate optical axes are provided for the projection point and the sensing point. However certain improvements may be obtained independent of the optical axes provided for the projection point and the sensing point.

As set out above in the background section, it is known to provide a sensing point and projection point which are coincident, and thus provided on the same optical axis. For such an arrangement, the advantages associated with providing a field of view for the sensing device which is larger than the projected image of the projection device may still be obtained.

Specifically, the sensed region outside the display region may be used to provide additional functionality; and the provisions of a sensed region of a given size may be used for the projection of images of any size up to the sensed area size, i.e. boards of different sizes.

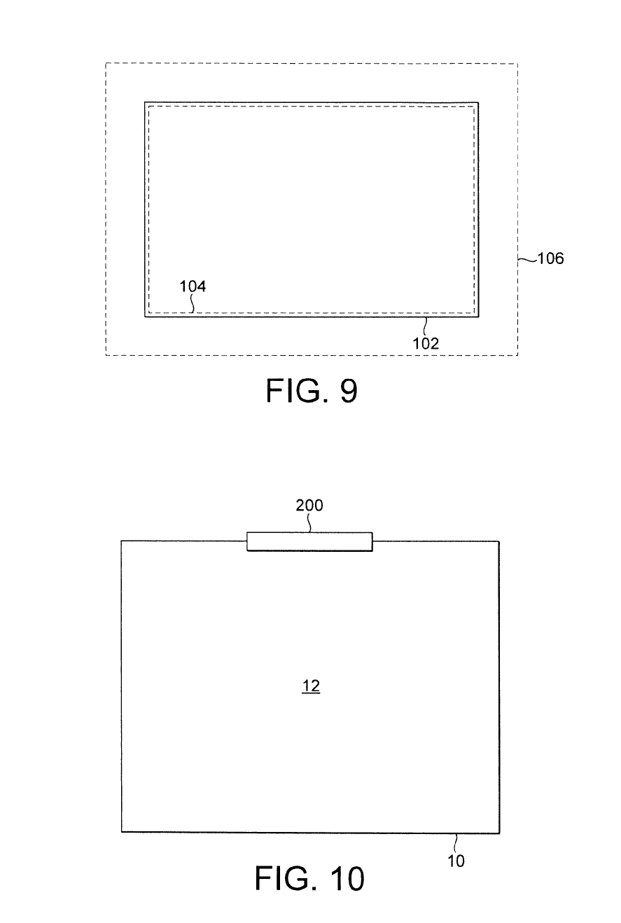

With reference to FIG. 9, there is illustrated an example arrangement. Reference numeral 102 denotes a whiteboard, and reference numeral 104 denotes a dashed line rectangle which constitutes the display region within which images are displayed on the whiteboard 102. Reference numeral 106 denotes a dashed line rectangle which constitutes the sensing region within which the sensing device is adapted to sense. The sensing device is thus able to sense points outside the of the display region, such that gestures in this region may be sensed for example. For example a user may touch the side of the whiteboard 102, such gesture turning the whiteboard on or off.

With reference to the exemplary arrangements described herein illustrating two distinct and separate optical axes, in the exemplary arrangements a single boom arrangement is provided to house both the sensing device and the projection device and provide the respective sensing point and projection point on the respective sensing and projection axes.

In an alternative arrangement, respective stalks can be provided for each axis.

Whilst the projection axis may be central to an edge of the displayed image, the sensing axis can be provided either side of the projection axes.

In a system employing a sensing device such as a camera as described in the foregoing, there is provided an apparatus for illuminating the surface of the display area with an illumination filed of infra-red light.

The foregoing arrangements can utilise any technique for illuminating the display surface with infra-red illumination, and various techniques are known in the art, and as such no specific description of a particular illumination technique is set out.

There is, however, now described a particular illumination technique which may be advantageously implemented in a system utilising the above techniques, more generally may be utilised in any system in which infra-red illumination of a display surface of an interactive display system is required.

With reference to FIG. 10 there is illustrated the display surface 12 of an interactive whiteboard 10 as shown in earlier figures. Also shown is the provision of an illumination unit 200. The provision of the illumination unit 200 is not limited to an interactive whiteboard, and the unit 200 may generally be provided on any surface which is to provide an interactive display surface.

FIG. 10 does not show any details of the projection or sensing of earlier figures, for ease of explanation. It will be understood that the illumination unit 200 may be used in combination with the arrangements of earlier figures, and may or in general may be used in any arrangements where it is desired to provide an infra-red illumination field for an interactive display. The IR field may be intended to be utilised to provide an object for the camera to track due to the IR field being interfered with.

The illumination unit is provided to illuminate the surface 12 with infra-red illumination, so as to provide an illumination field or light curtain of infra-red across the entire surface.

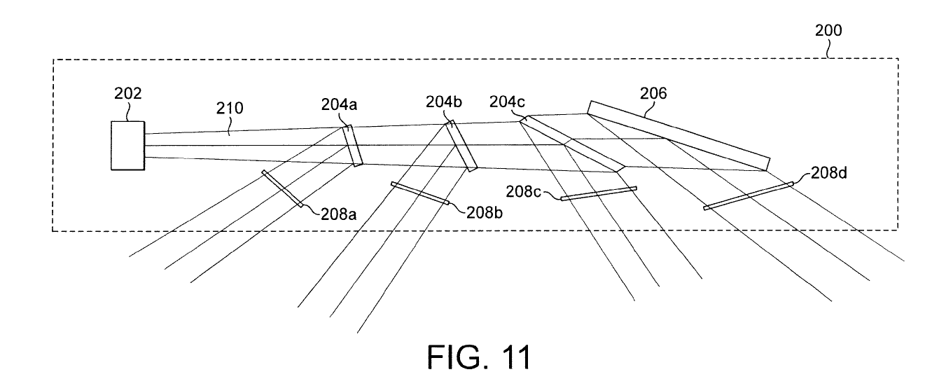

The illumination unit 200 generates a plurality of overlapping beams from light produced by a single infra-red laser diode to produce an illumination field that covers the display surface in a contiguous fashion. In a preferred implementation, the illumination unit 200 generates an illumination field of four overlapping beams using light from a single infra-red laser diode. An exemplary implementation of the illumination unit 200 is illustrated in FIG. 11.

As illustrated in FIG. 11, the illumination unit comprises a laser diode 202, three partial reflectors 204a to 204c, a reflector 206, and four diffusers 208a to 208d.

The main optical functions of the illumination unit 200 are the collimation of the laser diode 202, splitting the collimated beam into four sub-beams, and diffusing each of the four sub-beams in one dimension.

The collimated beam is split using three partial reflectors 204a to 204c. Each partial reflector partially passes the incident light beam, and partially reflects the incident light beam. A final high reflecting mirror 206 fully reflects the incident light beam.

The partial reflectors 204a to 204c are selected to reflect the correct amount of light to ensure that the laser energy is evenly distributed over the resulting four beams. The mirrors are actively aligned to create a precise overlap of all four beams, and to ensure that the resulting illumination field produces a planar field which is parallel to the plane of the display surface.

As illustrated in FIG. 11 each partial reflector/reflector is orientated at a different angle with respect to the infra-red light beam emitted by the infra-red light source 202, such that each reflector (or partial reflector) is orientated or disposed at a different angle to a beam of received light from the light source than the any other reflector (or partial reflector). Thus for any given beam of light from the source 202, the angle with respect to that beam for each reflector (or partial reflector) on which that beam is incident is different. For a beam which has multiple rays in different directions, each reflector (or partial reflector) has a different orientation angle to a given ray. Preferably the light beam is parallel to one side of a display region—the reflectors or partial reflectors can also be considered as orientated or disposed at different angles to one side of the display region.

As illustrated in FIG. 11, each partial reflector/reflector has an incident surface of a different physical length for the light beam. Partial reflectors/reflectors are longer the greater distance they are from the infra-red light source.

Each of the four beams is diffused using custom one-dimensional engineered diffusers 208a to 208d. The diffusers are also actively aligned to ensure overlap of the beams over their entire width.

Thus there is disclosed an interactive display system comprising a display surface and a display controller for generating an infra-red illumination field across the display surface.

The display controller includes an infra-red light source 202.

The display controller also includes a first partial reflector 204a for receiving the light from the light source and for: partially reflecting the light to create a first partial illumination field; and for partially transmitting the light to a second reflector.

The second reflector is for at least partially reflecting the light transmitted from the first partial reflector to create a second partial illumination field.

The first and second partial light curtains form, in combination, an infra-red illumination field across the display surface.

The second reflector 204b is preferably a partial reflector, the second reflector 204b partially transmitting the light to a third reflector. The third reflector is for reflecting the light transmitted from the second partial reflector 204b to create a third partial illumination field. The first, second and third partial illumination fields form, in combination, the infra-red illumination field across the display surface.

The third reflector 204c may be a partial reflector, the third reflector 204c partially transmitting the light to a fourth reflector. The fourth reflector may reflect the light transmitted from the third partial reflector to create a fourth partial illumination field, wherein the first, second, third and fourth partial illumination fields form, in combination, the infra-red illumination field across the display surface.

The fourth reflector 206 may be a full reflector.

Any method or process described herein may be implemented as a computer controlled method or process. Any method or process may be a computer program comprising computer program code which, when operated on a computer system, carries out the defined method or process. A computer program product, such as a computer storage device, such as a computer memory, may store computer program code for carrying out any method or process described here. A computer program product may be a computer memory, may be other storage device associated with a computer, or may be a stand-alone storage device associated with a computer such a memory disk or memory stick, such as that provided by a USB memory stick.

The invention has been described herein with reference to particular examples associated with interactive systems, and with reference to a particular exemplary interactive system. The invention is not limited to any described example or arrangement, and the scope of protection is defined by the appended claims.

1.-25. (canceled)

26. An interactive display system comprising a display surface and a display controller for generating an infra-red illumination field across the display surface, the display controller including an infra-red light source, a first partial reflector for receiving the light from the light source and for partially reflecting the light to create a first illumination field and partially transmitting the light to a second reflector, the second reflector for partially reflecting the light transmitted from the first partial reflector to create a second illumination field, wherein the first and second illumination fields form, in combination, the infra-red illumination field across the display surface, wherein the first reflector is disposed at a different angle to a beam of received light from the light source than the second reflector.

27. The interactive display surface of claim 26 wherein the incident surface, on which the light from the light source is incident, of the second reflector is longer than the incident surface of the second reflector.

28. The interactive display system of claim 26 further comprising a first and second diffuser for respectively diffusing the reflected light from the first partial reflector and the second reflector.

29. The interactive display system of claim 26 wherein the second reflector is a partial reflector, the second reflector partially transmitting the light to a third reflector, the third reflector for reflecting the light transmitted from the second partial reflector to create a third illumination field, wherein the first, second and third illumination fields form, in combination, the infra-red illumination field across the display surface, wherein the third reflector is disposed at a different angle to the beam of received light from the light source than the first and second reflectors.

30. The interactive display surface of claim 29 wherein the incident surface of the third reflector is longer than the incident surface of the second reflector.

31. The interactive display system of claim 29 further comprising a third diffuser for respectively diffusing the reflected light from the third reflector.

32. The interactive display system of claim 29 wherein the third reflector is a partial reflector, the third reflector partially transmitting the light to a fourth reflector, the fourth reflector for reflecting the light transmitted from the third partial reflector to create a fourth illumination field, wherein the first, second, third and fourth illumination fields form, in combination, the infra-red illumination fields across the display surface, wherein the fourth reflector is disposed at a different angle to the beam of received light from the light source from the first, second and third reflectors.

33. The interactive display surface of claim 32 wherein the incident surface of the fourth reflector is longer than the incident surface of the third reflector.

34. The interactive display system of claim 32 further comprising a fourth diffuser for respectively diffusing the reflected light from the fourth reflector.

35. The interactive display system of claim 32 wherein the fourth reflector is a full reflector.

36. The interactive display system of claim 29 wherein the infra-red light source is a laser.

37. The interactive display system of claim 29 wherein the infra-red light source generates a collimated beam.

38.-105. (canceled)
